(19) United States
(12) Patent Application Publication
(10) Pub. No.: US 2005/0002354 A1
(43) Pub. Date: Jan. 6, 2005

(54) Systems and methods for providing network communications between work machines

(76) Inventors: Thomas J. Kelly, Dunlap, IL (US); Daniel C. Wood, East Peoria, IL (US); Alan L. Ferguson, Peoria, IL (US); Paul W. Bierdeman, East Peoria, IL (US); Brian L. Jenkins, East Peoria, IL (US); Trent R. Meiss, Eureka, IL (US); Andrew J. Swanson, Peoria, IL (US)

Correspondence Address: Finnegan, Henderson, Farabow,;Garrett & Dunner, L.L.P., 1300 I Street, N.W., Washington, DC, 20005-3315, US

(21) Appl. No.: 10/646,809

(22) Filed: Aug. 25, 2003

Related U.S. Application Data
(60) Provisional application No. 60/483,915, filed on Jul. 2, 2003.

(51) Int. Cl. H04L 12/28; H04L 12/56

(52) U.S. Cl. 370/329; 370/401

(57) ABSTRACT

A method and system are provided to perform a process of dynamically establishing an ad-hoc network including a plurality of work machines, one or more of which move within a work environment, and each of which includes a gateway. The process may be performed by a respective gateway included within a respective one of the work machines and includes determining a first set of work machines that are within direct communication range of the respective work machine based on the respective work machine's current location within the work environment. Further, the process includes determining a second set of work machines that are in direct communication range of one or more of the work machines in the first set. The process may also include forwarding a packet received from a first work machine included in the first set to a second work machine included in the first set based on a determination that the second work machine is either directly or indirectly within communication range of a third work machine included the second set. In addition, the process includes updating the work machines included in at least one of the first and second set of work machines based on at least one of (i) the respective work machine changing locations within the work environment and (ii) any of the work machines included in the first or second sets changing locations within the work environment.

### CROSS REFERENCE TO RELATED APPLICATIONS

This application claims the benefit of U.S. Provisional Application Ser. No. 60/483,915 entitled “SYSTEMS AND METHODS FOR INTERFACING OFF-BOARD AND ON-BOARD NETWORKS IN A WORK MACHINE,” filed Jul. 2, 2003, owned by the assignee of this application and expressly incorporated herein by reference in its entirety.

This application is related to U.S. application Ser. No. ______, entitled “SYSTEMS AND METHODS FOR PROVIDING SERVER OPERATIONS IN A WORK MACHINE,” filed Aug. 25, 2003, U.S. application Ser. No. ______, entitled “SYSTEMS AND METHODS FOR PERFORMING PROTOCOL CONVERSIONS IN A WORK MACHINE,” filed Aug. 25, 2003, U.S. application Ser. No. ______, entitled “SYSTEMS AND METHODS FOR PROVIDING SECURITY OPERATIONS IN A WORK MACHINE,” filed Aug. 25, 2003, and U.S. application Ser. No. ______, entitled “METHODS AND SYSTEMS FOR PROVIDING PROXY CONTROL FUNCTIONS IN A WORK MACHINE,” filed Aug. 25, 2003, each owned by the assignee of this application and expressly incorporated herein by reference in its entirety.

### TECHNICAL FIELD

This invention relates generally to network interface systems and more particularly, to systems and methods for providing network communications between work machines.

### BACKGROUND

An important feature in modern work machines (e.g., fixed and mobile commercial machines, such as construction machines, fixed engine systems, marine-based machines, etc.) is the on-board communications, monitoring, and control network. An on-board network includes many different modules connected to different types of communication links. These links may be proprietary and non-proprietary, such as manufacturer-based data links and communication paths based on known industry standards (e.g., J1939, RS-232, RP 1210, RS-422, RS-485, MODBUS, CAN, etc.). Other features implemented with work machines are off-board systems and networks, such as wireless networks (e.g., cellular), satellite networks (e.g., GPS), and TCP/IP-based networks.

On-board modules may communicate with other on-board or off-board modules to perform various functions related to the operation of the work machine. For example, display modules may receive sensor data from an engine control module via a J1939 data link, while another control module connected to a proprietary data link may provide data to another module connected to the same link. Also, an on-board module may send data to an off-board system using a different communication path extending from the work machine to the off-board system.

Problems arise, however, when modules connected to different types of data links need to communicate. To address these problems, conventional systems may incorporate various interface devices to facilitate communications between different types of data links. Although this solution may be functionally acceptable in some instances, their implementations are restricted due to the hardware and service capabilities associated with the types of data links used in a work machine. Further, the additional hardware may take up valuable space needed for other components used by the machine.

One of these components is the machine's on-board computer system. Today, work machines must not only include various interface devices for facilitating communications in multi-protocol environments, but they require the processing capabilities to service this traffic. Further, the complexity and applications of work machines require these machines to provide other types of data management services. However, work machines have limitations when accessing off-board resources to provide these services. For example, conventional machines may require information from a remote site to perform on-site operations. To obtain this information, these systems may have limited options, such as the operator contacting the remote site via wireless networks (e.g., user cellphone) and taking the machine to a site where the information may be downloaded to the machine (e.g., a diagnostic or data download center).

In addition to the shortcomings associated with resource accessibility, problems may arise when work machines need to communicate with each other while traveling within or between work environments. U.S. Pat. No. 5,850,592 to Ramanathan implements a system that allows mobile stations to organize themselves into a hierarchical network in which some of the stations operate as message gateways for a cluster of stations. Each station is capable of transmitting messages on either a high power level or a low power level. Although the system disclosed by Ramanathan allows mobile stations to communicate with each other, it does so through cluster gateway stations that are configured to exchange messages between each other at the high power level. Because only cluster gateways are used to pass messages to affiliated non-cluster gateway stations, the system is restricted in its ability to pass information freely between the mobile stations. Further, when two cluster gateways are within a predetermined proximity of each other, the system requires one of them to stand down as a cluster gateway to eliminate redundancy.

Methods, systems, and articles of manufacture consistent with certain embodiments of the present invention are directed to solving one or more of the problems set forth above.

### SUMMARY OF THE INVENTION

A method is provided for dynamically establishing an ad-hoc network including a plurality of work machines, one or more of which may move within a work environment, and each of which includes a gateway. The method may be performed by a respective gateway included within a respective one of the work machines and includes determining a first set of work machines that are within direct communication range of the respective work machine based on the respective work machine's current location within the work environment. Further, the method includes determining a second set of work machines that are in direct communication range of one or more of the work machines in the first set. The method may also include forwarding a packet received from a first work machine included in the first set to a second work machine included in the first set based on a determination that the second work machine is either directly or indirectly within communication range of a third work machine included in the second set. In addition, the method includes updating the work machines included in at least one of the first and second set of work machines based on at least one of (i) the respective work machine changing locations within the work environment and (ii) any of the work machines included in the first or second sets changing locations within the work environment.

In another embodiment, a system is provided for dynamically establishing communications between work machines that may move within a work environment. The system includes a first work machine positioned in a first location within the work environment and a first gateway included in the first work machine that interconnects an on-board data link with an off-board data link. The gateway includes a network table that identifies work machines that are either directly or indirectly within communication range of the first work machine, wherein the network table identifies a first set of work machines that are within communication range of the first work machine and identifies a second set of work machines that are within communication range of any of the work machines in the first set. Further, the first gateway is configured to update the network table based on at least one of (i) the first work machine changing locations within the work environment and (ii) any of the work machines included in the first or second sets changing locations within the work environment. Also, the gateway may receive a packet over the off-board data link from a second work machine included in the first set, wherein the packet identifies a destination work machine, and forwards the received packet to a third work machine included in the first set based on a determination that the destination work machine is associated with the third work machine in the network table. Moreover, the gateway may forward the received packet to the on-board data link based on a determination that the first work machine is the destination work machine.

### BRIEF DESCRIPTION OF THE DRAWINGS

The accompanying drawings, which are incorporated in and constitute a part of this specification, illustrate several aspects of the invention and together with the description, serve to explain the principles of the invention. In the drawings:

FIG. 1 illustrates a block diagram of an exemplary system that may be configured to perform certain functions consistent with embodiments of the present invention;

FIG. 2 illustrates a block diagram of an exemplary gateway consistent with embodiments of the present invention;

FIG. 3 illustrates a block diagram of an exemplary software architecture for a gateway consistent with embodiments of the present invention;

FIG. 4 illustrates a block diagram of an exemplary off-board server configuration consistent with embodiments of the present invention;

FIG. 5 illustrates an exemplary ad-hoc work machine network environment consistent with embodiments of the present invention;

FIGS. 6A and 6B illustrate exemplary network tables associated with the ad-hoc network environment shown in FIG. 5, consistent with embodiments of the present invention;

FIG. 7 illustrates another exemplary ad-hoc work machine environment consistent with embodiments of the present invention;

FIG. 8 illustrates an exemplary network table associated with the ad-hoc network environment shown in FIG. 7, consistent with embodiments of the present invention;

FIG. 9 illustrates a flowchart of an exemplary ad-hoc admission process consistent with embodiments of the present invention;

FIG. 10 illustrates a flowchart of an exemplary ad-hoc network communications process consistent with embodiments of the present invention;

FIG. 11 illustrates an exemplary multi-layer ad-hoc network environment consistent with embodiments of the present invention;

FIGS. 12A and 12B illustrate exemplary first and second level network tables, respectively, consistent with embodiments of the present invention;

FIG. 13 illustrates a flowchart of an exemplary multi-layer ad-hoc communications process consistent with embodiments of the present invention;

FIG. 14 illustrates an exemplary remote operation environment consistent with embodiments of the present invention; and

FIG. 15 illustrates a flowchart of an exemplary remote operation process consistent with embodiments of the present invention.

### DETAILED DESCRIPTION

Reference will now be made in detail to the exemplary aspects of the invention, examples of which are illustrated in the accompanying drawings. Wherever possible, the same reference numbers will be used throughout the drawings to refer to the same or like parts.

Overview

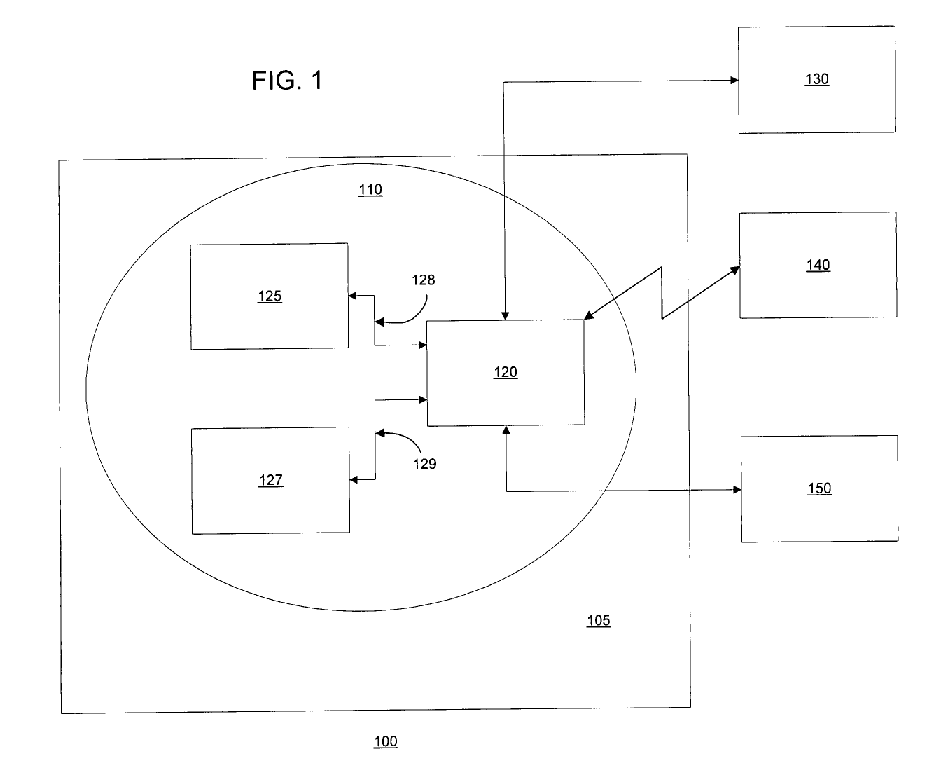

FIG. 1 illustrates an exemplary system 100 in which features and principles consistent with an embodiment of the present invention may be implemented. As shown in FIG. 1, system 100 may include a work machine 105 including an on-board system 110 comprising a gateway 120 and on-board modules 125, 127. System 100 may also include one or more off-board systems 130-150. Although gateway is shown as a separate element, methods and systems consistent with the present invention may allow gateway 120 to be included in one or more elements, such as on-board modules 125 and/or 127.

A work machine, as the term is used herein, refers to a fixed or mobile machine that performs some type of operation associated with a particular industry, such as mining, construction, farming, etc. and operates between or within work environments (e.g., construction site, mine site, power plant, etc.). A non-limiting example of a fixed machine includes an engine system operating in a plant, off-shore environment (e.g., off-shore drilling platform). Non-limiting examples of mobile machines include commercial machines, such as trucks, cranes, earth moving vehicles, mining vehicles, backhoes, material handling equipment, farming equipment, marine vessels, aircraft, and any type of movable machine that operates in a work environment.

An on-board module, as the term is used herein, may represent any type of component operating in work machine 105 that controls or is controlled by other components or sub-components. For example, an on-board module may be an operator display device, an Engine Control Module (ECM), a power system control module, a Global Positioning System (GPS) interface device, an attachment interface that connects one or more sub-components, and any other type of device work machine 105 may use to facilitate operations of the machine during run time or non-run time conditions (i.e., machine engine running or not running, respectively).

An off-board system, as the term is used herein, may represent a system that is located remote from a work machine, such as remote from machine 105. An off-board system may be a system that connects to on-board system 110 through wireline or wireless data links. Further, an off-board system may be a computer system including known computing components, such as one or more processors, software, display, and interface devices that operate collectively to perform one or more processes. Alternatively, or additionally, an off-board system may include one or more communications devices that facilitates the transmission of data to and from on-board system 110.

Gateway 120 represents one or more interface devices configured to perform functions consistent with various embodiments of the present invention. Gateway 120 may be configured with various types of hardware and software depending on its application within a work machine. Thus, in accordance with embodiments of the invention, gateway 120 provide interface capability that facilitates the transmission of data to and from on-board system 110, performs various data processing functions, and maintains data for use by one or more on-board modules or off-board systems. For example, gateway 120 may be configured to perform protocol conversions (e.g., tunneling and translations), intelligent routing, and server-based operations, such as data provisioning, application provisioning, Web server operations, electronic mail server operations, data traffic management, and any other type of server-based operations that enable on-board system 110 to retrieve, generate, and/or provide data with on-board and/or off-board systems.

For clarity of explanation, FIG. 1 depicts gateway 120 as a distinct element. However, consistent with principles of the present invention, “gateway” functionality may be implemented via software, hardware, and/or firmware within one or more modules (e.g., 125, 127) on a network, which controls a system on a work machine and communicates with an off-board system. Thus, gateway 120 may, in certain embodiments, represent functionality or logic embedded within another element.

On-board module 125 represents one or more on-board modules connected to one or more proprietary data links 128 included in on-board system 110. On-board module 127 may be one or more on-board modules connected to a non-proprietary data link 129, such as Society of Automotive Engineers (SAE) standard data links including Controller Area Network (CAN), J1939, etc. standard data links.

As shown in FIG. 1, gateway 120 also interfaces with one or more off-board systems 130-150. In one exemplary embodiment, off-board systems 130-150 include, for example, computer system 130, computer system 140, and service port system 150.

Computer system 130 represents one or more computing systems each executing one or more software applications. For example, computer system 130 may be a workstation, personal digital assistant, laptop, mainframe, etc. Computer system 130 may include Web browser software that requests and receives data from a server when executed by a processor and displays content to a user operating the system. In one embodiment of the invention, computer system 130 is connected to on-board system 110 through one or more wireline based data links, such as a Local Area Network (LAN), an Extranet, and the Internet using an Ethernet connection based on TCP/IP.

Computer system 140 also represents one or more computing systems each executing one or more software applications. Computer system 140 may be a workstation, personal digital assistant, laptop, mainframe, etc. Also, computer system 140 may include Web browser software that requests and receives data from a server when executed by a processor and displays content to a user operating the system. In one embodiment of the invention, computer system 140 is connected to on-board system 110 through one or more wireless based data links, such as cellular, satellite, and radio-based communication data links.

Computer systems 130 and 140 may each be associated with a user (e.g., customer), multiple users, a business entity (dealer, manufacturer, vendor, etc.), a department of a business entity (e.g., service center, operations support center, logistics center, etc.), and any other type of entity that sends and/or receives information to/from on-board system 110. Further, computer system 130 and 140 may each execute off-board software applications that download or upload information to/from on-board system 110 via gateway 120.

In certain embodiments, computer systems 130 and 140 may include one or more controllers, such as Programmable Logic Controllers (PLCs) that may be used in plants and/or factories.

Service system 150 represent one or more portable, or fixed, service systems that perform diagnostics and/or service operations that include receiving and sending messages to on-board system 110 via gateway 120. For example, service port system 150 may be a electronic testing device that connects to on-board system 120 through an RS-232 serial data link. Using service port system 150, a user or an application executed by a processor may perform diagnostics and service operations on any of on-board system modules 125, 127 through gateway 120.

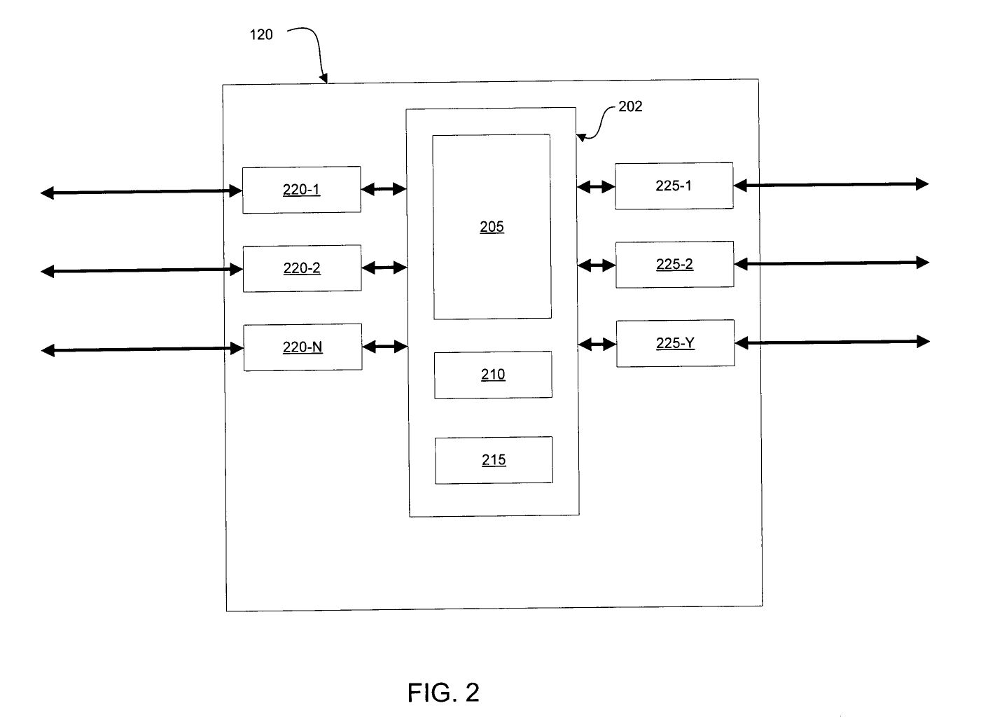

In one embodiment, gateway 120 may include various computing components used to perform server based services (e.g., communications services, file services, database services, etc.) for on-board system 110. FIG. 2 shows an exemplary block diagram of gateway 120 consistent with embodiments of the present invention. As shown, gateway 120 includes a digital core 202, on-board data link port components 220-1 to 220-N, and off-board data link port components 225-1 to 225-Y.

Digital core 202 includes the logic and processing components used by gateway 120 to perform its interface, communications, and server functionalities. In one embodiment, digital core 202 includes one or more processors 205 and internal memories 210 and 215. Processor 205 may represent one or more microprocessors that execute software to perform the gateway features of the present invention. Memory 210 may represent one or more memory devices that temporarily store data, instructions, and executable code, or any combination thereof, used by processor 205. Memory 215 may represent one or more memory devices that store data temporarily during operation of gateway 120, such as a cache memory, register devices, buffers, queuing memory devices, and any type of memory device that maintains information. Memories 210 and 215 may be any type of memory device, such as flash memory, Static Random Access Memory (SRAM), and battery backed non-volatile memory devices.

On-board data link ports 220-1 to 220-N represent one or more interface devices that interconnect one or more on-board data links with digital core 202. For example, on-board data link ports 220-1 to 220-N may connect to proprietary and non-proprietary data links 128, 129, respectively. In one embodiment, on-board data link ports 220-1 to 220-N interfaces with one or more proprietary data links, one or more CAN data links (e.g., J1939, galvanized isolated CAN data links, etc.), one or more RS-232 serial based data links (e.g., MODBUS, PPP, NMEA183, etc.), and one or more RS-242 data links. On-board data link ports 220-1 to 220-N may also include virtual (i.e., software) ports that allow a single connection to act as if there were multiple connections.

Off-board data link ports 225-1 to 225-Y represent one or more interface devices that interconnect one or more off-board data links with digital core 202. For example, off-board data link ports 225-1 to 225-Y may connect gateway 120 to one or more RS-232 data links, RS-485 data links, Ethernet data links, MODBUS data links, radio data links, infra-red data links, and/or satellite data links, etc. It is appreciated that gateway 120 may be configured to interface with any type of data link used in an on-board or off-board system network.

The gateway 120 shown in FIG. 2 is exemplary and not intended to be limiting. A number of additional components may be included in gateway 120 that supplement and/or compliment the operations of digital core 202 and data link ports 220 and 225. For example, gateway 120 may also include an internal power supply, a real time clock, hour meter, sensor inputs for receiving signals from one or more sensors monitoring the operations of a work machine component, memory arrays, etc. Moreover, as explained, gateway 120 may, in certain embodiments, be implemented (e.g., via logic and/or circuitry) within one or more modules coupled to a given network.

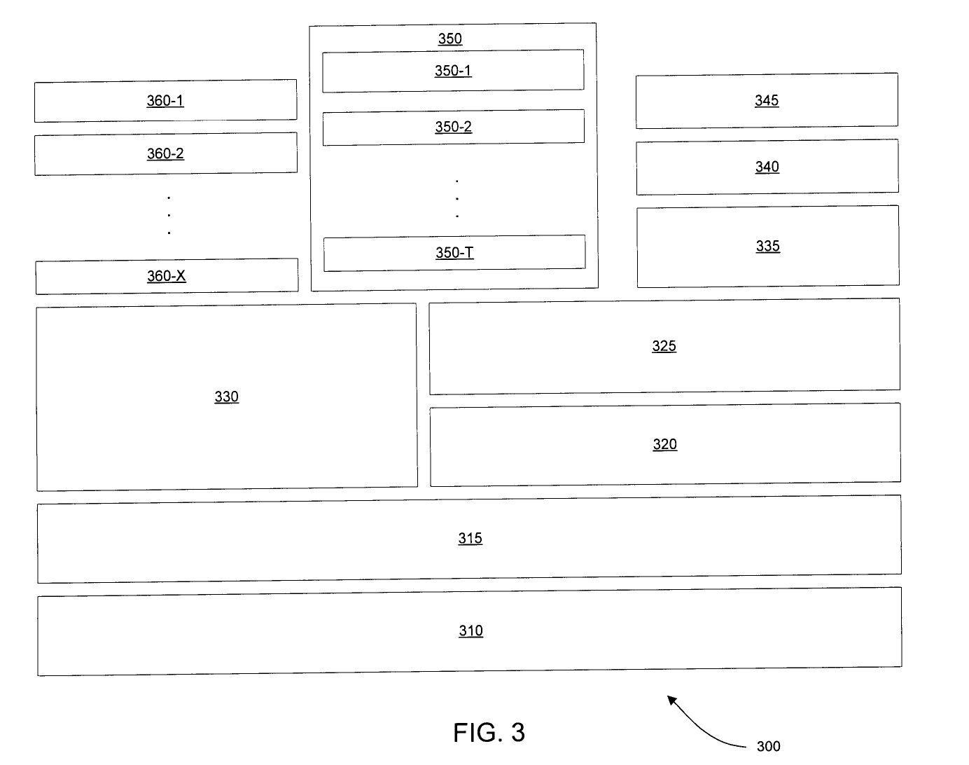

In operation, digital core 202 executes program code to facilitate communications between on-board modules and/or off-board systems. In one embodiment of the present invention, memory 210 includes application and server-based software programs that allow information received through either data link ports 220 and 225 to be processed and/or transferred to the proper destination module/system in the proper format. FIG. 3 illustrates an exemplary software architecture model 300 that may be implemented by gateway 120 consistent with embodiments of the present invention.

Exemplary model 300 may include hardware interface software, such as boot executable software and driver software layer 310, that drive the on-board and off-board data link ports 220 and 225 connecting the multiple types of data links to gateway 120 (e.g., Ethernet, RS-232, CAN, proprietary data links, etc.). A core hardware access layer 315 interfaces boot executable layer 310 and core software layer 330, which includes software associated with run time operations of gateway 120. Layer 320 includes operating system software executed by processor 205, and layer 325 is a network stack level including one or more protocol stacks used to perform communication services, such as formatting data messages for specific protocols, etc. In one embodiment, model 300 may also include a Web server layer 335 that includes server software used by gateway 120 to perform Web server operations, such as HTML processing, content generation, Web page request processing, etc. Further, model 300 may also include one or more layers 340-360 representing application programs executable by gateway 120. For example, layers 340, 345 may represent server applications executed by gateway 120 to perform certain services, such as data provisioning, application management, traffic management, etc. Layers 360-1 to 360-X may represent application programs that perform operations associated with functions typically performed by certain types of on-board modules connected to an on-board network, such as a Customer Communication Module (CCM), a communication adapter, a GPS Interface Module (GPSIM), a third party interface software, an Engine Vision Interface Module (EVIM), and a product link module.

Model 300 may also include an inter-data link gateway layer 350 that includes one or more gateway applications 350-1 to 350-T, that perform protocol conversion operations for converting information associated with one type of data link to another. The conversion operations may include protocol translation and tunneling features. Processor 205 may execute a selected one of application programs 350-1 to 350-T based on the type of format required by an outgoing data link. For example, application layer 350-1 may represent a protocol conversion program that allows data messages received in a proprietary data link to be converted to a J1939 format for transmission across a J1939 data link. Other types of conversion applications may be configured in model 300 including application layers that combine one or more protocol conversion capabilities.

Communication Server Applications

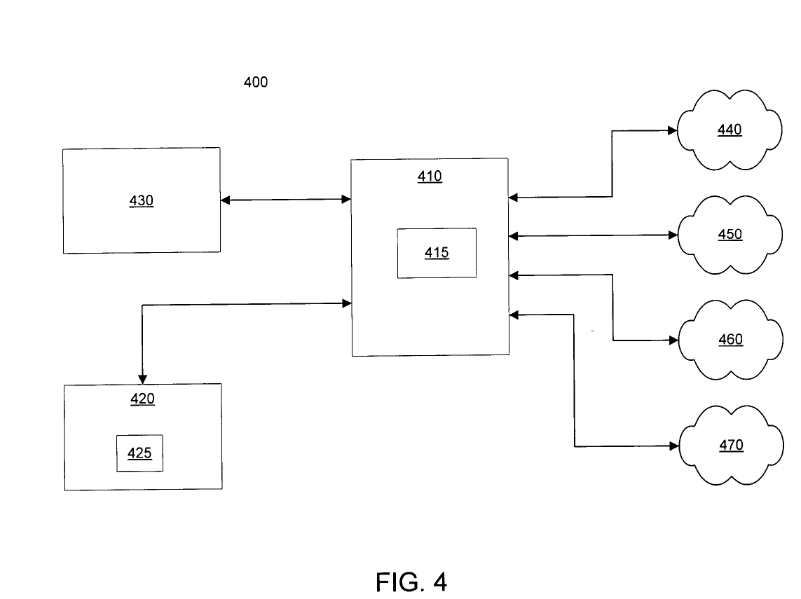

Methods and systems consistent with embodiments of the present invention may include one or more work machines that each include one or more gateways 120 that operate as an embedded communications server. In these embodiments, gateway 120 includes hardware and software that enable it to operate in a communications server-like fashion, receiving requests for information and servicing those requests. When embedded in a mobile work machine, gateway 120 may operate as a communications server by dynamically servicing requests from off-board systems and other work machines. FIG. 4 illustrates a block diagram showing an exemplary off-board server system 400 consistent with embodiments of the present invention.

As shown in FIG. 4, a work machine 410 including a gateway 415, which may be configured, and operates, similarly to gateway 120 described in connection with FIGS. 1 and 2. Gateway 415 may execute one or more server applications that allow work machine 410 to communicate with one or more off-board elements, such as another work machine 420, a Wide Area Satellite Wireless Network (WASWN) 430, a Wireless Local Area Network (WLAN) 440, a Wide-Area Terrestrial Wireless Network (WATWLN) 450, a Wide Area Network (WAN) 460, and one or more external systems 470.

Work machine 420 may include a gateway 425 that may be configured, and operates, similar to gateway 120. Work machine 420 may be a mobile or fixed work machine connected to work machine 410 through a wireline or wireless data link. WASWN 430 may be a satellite radio network that includes infrastructure allowing communications between one or more satellite devices and a remote system, such as computer system 140 described in connection with FIG. 1. WLAN 440 may be a wireless radio network including infrastructure that facilitates communications between one or more wireless radio devices and a remote system, such as computer system 140. WATWLN 450 may be a wireless network that includes infrastructure allowing communications between one or more cellular devices and a remote system (e.g., computer system 140). WAN 460 may be a network including the infrastructure that allows for Internet access, such as the World Wide Web. External system 470 may represent a remote system that communicates with gateway 415 through a wireless or wireline connection, such as computer system 130, computer system 140, or service port system 150.

Although FIG. 4 shows work machine 420 and external system 470 connected to work machine 410 through dedicated data links, these elements may also be configured to communicate with gateway 415 through one or more of networks 430, 440, 450, and 470.

Gateway 120 includes one or more communications applications that are leveraged by sister applications to control communication processes between data links. In one embodiment, gateway 120 may perform protocol translation processes to facilitate communications between different types of data links, whether on-board or off-board. As used herein, the term “translation” refers to converting messages from one data link protocol into comparable messages of another protocol. For example, data messages including Parameter IDentifier (PID) information may be translated from an off-board data link protocol (e.g., Ethernet) into data values compatible with an on-board data link protocol (e.g., J1939). The PIDs may be associated with one or more operational parameters of work machine 105, such as engine speed, injection rates, component and/or area temperatures, pressures, etc. corresponding to systems, modules, and components located on work machine 105. Further, the parameters may be associated with engine diagnostic and performance parameters associated with an ECM. A data message may include one or more commands to adjust a PID data value based on a requested action directed to work machine 105. For example, a data message may include a request to increase the engine speed of work machine 105 by adjusting the data values associated with the PID corresponding to engine RPM.

Consistent with principles of the present invention, a communication application may perform translating processes for any number of protocols. Packets of messages from multiple and different data links may be discretely or simultaneously translated and sent out on a single data link. Message packets may also be received from a single data link and discretely or simultaneously translated and sent out over multiple and different data links. Non-limiting examples of translations include: (1) CDL and J1939 to MODBUS; (2) CDL to ISOI1783; (3) CDL to J1939; (4) ATA to J1939; and vice versa.

Consistent with principles of the present invention, gateway 120 may maintain a translation data structure, such as a translation table, that maps parameters between data links for facilitating protocol translations. Gateway 120 may access the translation table in order to convert information (e.g., PID data values) from one protocol compatible data value to another. In certain embodiments, the translation table may be stored in a memory device within gateway 120, such as memory 210, and accessed by processor 202. Further, the translation table may include a plurality of parameter identifiers (PIDs) representing system parameters associated with various data link protocols. For example, a first PID may represent an engine speed (RPM) parameter associated with certain protocols and a second PID may represent a temperature parameter. The translation table may include any number of different PIDs.

Also, the translation table may also include one or more scaling factors, each representing a data link “view” Each view may correspond to a particular protocol interfaced by gateway 120, such as a proprietary data link view, an Ethernet data link (i.e., Web) view, a J1939 view; and a RS-422 view. The translation table may include any number of views corresponding to data links interfaced by gateway 120. Each “view” may enable its associated data link to interpret parameter data stored in a universal storage location. This location represents a memory location or locations that store one or more values corresponding to a particular parameter (i.e., parameter data). Parameter data may be received from one or more data links interfaced by gateway 120.

Moreover, each data link view may include a scale factor corresponding to translation logic used by gateway 120 to translate parameter data stored in the universal storage to an appropriate format for the particular data link protocol. In certain embodiments, all views represented by a translation table may support a given parameter. For example, an RPM parameter may exist in all of the protocols mapped by the translation table. In some cases, however, certain parameters may be supported by less than all of the views mapped by the translation table. For example, a temperature parameter may be supported by CDL, Ethernet, and J1939 but not by RS-422. The scale factor for such non-supporting views may be null or set to zero.

In addition, each view in the translation table may include a specific read/write privilege to the universal storage location. That is, certain data links may be assigned write privileges to this location, while other data links have only read access.

Consistent with embodiments of the present invention, the translation table may be pre-configured with a plurality of parameter identifiers and scale factors corresponding to a plurality of data links interfaced by gateway 120. In operation, gateway 120 may receive a message, including a PID and corresponding parameter data, from a particular data link. In response to such a message, gateway 120 may extract the PID and store the parameter data in the universal storage location. In addition, gateway 120 may use the PID to scale the parameter data according to the scale factors included in the translation table, thereby creating multiple “views” of the parameter data. In one example, gateway 120 may receive a request for parameter data from a particular data link. The request may include a PID corresponding to the requested data. In response to such a request, gateway 120 may extract the PID from the request and scale the requested parameter data (previously stored in the universal storage location) using a scale factor corresponding to the extracted PID and requesting data link protocol.

Firewall Server Applications

In another embodiment, gateway 120 may include a security application that operates as a firewall for controlling access to information and resources located in work machine 105. For example, by executing the security application, gateway 120 allows authorized off-board systems to collect information, modify parameters, and control a work machine through gateway 120, while unauthorized systems are prevented from doing the same. This feature allows gateway 120 to protect proprietary data associated with work machine 105 that should be shielded from unauthorized systems and/or users, while allowing authorized systems, processes, and/or users access to the same data.

The proprietary data protected by the gateway firewall may include, for example, the PID information specific to the operational parameters of work machine 105, such as engine speed, injection rates, component and/or area temperatures, pressures, etc. Based on the relationship between the proprietary data and work machine 105, gateway 120 may be configured to protect this information using the PID information itself as a security mechanism. For example, gateway 120 may perform a firewall application process consistent with certain embodiments related to the present invention.

For instance, an off-board system (e.g., off-board system 130, 140, 150) may generate a request directed to work machine 105. The request may be any type of request capable of being processed by gateway 120 and/or any on-board modules included in on-board system 110. In one embodiment, the request may be a server request, a Web server request, or a request for modifying an operating characteristic of work machine 105. The latter request may be a feature that is useful in remote control operations of work machine 105. For example, off-board computing system 140 may generate a request message including a command for changing a parameter data value for a particular parameter. In this case, the command may include a PID that identifies the particular parameter targeted for adjustment and a corresponding adjustment value. The command may include a request directing work machine 105 to increase its engine speed from 100 RPMs to 200 RPMs.

The off-board system may then send the request to gateway 120 over an appropriate off-board data link where it is received through a corresponding off-board data link port 225-1 to 225-Y. In response to the request, gateway 120, either through a communication application or other form of logic, software, hardware, etc., invokes the firewall application.

Based on the configuration of the firewall application, a first level of security is checked. In one embodiment, the first level of security may include checking the profile of the source of the request, which in the above example is off-board system 140. A profile is a map of access permissions for different types of users and/or systems providing requests to gateway 120. For example, various levels of access may be defined for different types of users operating off-board system 140. The profiles may be associated with different types of users, such as a customer, super customer, dealer, engineering, technician, and administrative. A customer profile may be associated with an access level provided to customers of a manufacturer of work machine 105. Users with a customer profile may have limited access to certain information maintained in work machine 105, such as read-only access to PID information. A super customer profile may be associated with customers with a higher level of access to a larger set of work machine information and/or control, such as adjusting parameter data values. A dealer profile may be associated with users that have limited access to work machine statistic information, such as position, hours operated, etc. An engineering profile is associated with users with another level of access to additional work machine information that allow the user to adjust the design of new versions of work machines based on the operating characteristics of work machine 105. A technician profile may be associated with users that have access to many or all of work machine 105's operational data, such as gauge data values, temperature, load information, etc. And, the administrative profile may be associated with a user having the highest level of access to work machine information, such as the ability to redefine, delete, and add PIDs. It will be appreciated that the afore-mentioned profiles are exemplary and that any number of different profiles may be supported by gateway 120.

The firewall application may also determine whether the source device (e.g., off-board system 140) and/or the user operating the device is authorized to communicate to gateway 120. If the request is not authorized, the firewall application may deny access to the requested information and/or service provided by gateway 120, and the application may provide a response message indicating the failure of the request and the security process may terminate.

On the other hand, if the source device and/or user is authorized to communicate with gateway 120, the firewall application may determine whether the request is a PID request, such as an instruction to adjust, add, delete, etc. a PID or parameter data value. If the request is not a request is not a PID request, the firewall application may then determine the type of request provided by the source device/user, described further below.

If, however, the request is a PID request, the firewall application may determine whether the request includes an authorized PID. In one embodiment, the firewall application may access a translation table to determine whether the PID included in the request matches any of the PIDs included in the translation table. If so, the request is authorized. If not, the request is not authorized and the request is denied.

If the PID is an authorized identifier (i.e., included in translation table), the firewall application may then determine the type of request provided by the source device/user. Based on the type of request, the firewall application process may forward the request to the appropriate application (e.g., server application, Web server application, communication application, etc.) for processing in accordance with any of the processes described above. In one embodiment, the type of request may include a command to modify a parameter identifier data value in the translation table. Further, the request may include a command to add or delete a parameter identifier in the translation table. Moreover, the request may include a command to access information stored in an on-board module located on one or more on-board data links (e.g., data links 128, 129).

It will be appreciated that the request may include commands or instructions for a number of different tasks, including, but not limited to, downloading information from work machine 105, pushing information to work machine 105, modifying information in work machine 105, controlling components or on-board modules of work machine 105, etc.

By executing a firewall application in a manner consistent with the embodiments described above, gateway 120 may protect proprietary information from unauthorized access and manipulation. In another embodiment, gateway 120 may store a data structure (e.g., separate table) that includes a list of authorized PIDs that may be accessed and/or controlled by authorized off-board systems or users.

In another embodiment of the present invention, if a request is bundled with multiple commands, (e.g., 5 commands with 5 PIDs), gateway 120 may determine whether any or all of the PIDs in the request have corresponding identifiers in a translation table. As a result, gateway 120 may allow a subset of the 5 commands (e.g., 3 out of the 5 command) to be processed based on the number of valid PIDs in the bundled message.

Ad-Hoc Networking with Gateway Embedded Work Machines

As an embedded communications server, gateway 415 may receive and service requests from any of the off-board elements shown in FIG. 4. In one embodiment, these requests may include packets of information provided by a mobile work machine and destined for another mobile work machine. Gateway 415 may be configured to perform communications applications that determine whether a received packet may be processed locally or should be routed to another work machine for subsequent processing or additional routing. This embodiment allows work machines to travel within or between work environments while dynamically establishing one or more ad-hoc work machine networks including one or more other work machines. An “ad-hoc work machine network,” as the term is used herein, represents a temporarily established network between two or more work machines. Thus, when any two work machines embedded with a gateway establish communications with each other, an ad-hoc work machine network is established. Additional work machines may gain admission to the network, allowing the network to dynamically change in member size. When a work machine travels out of communication range of any of the work machines within the temporarily established network, the moving machine is removed from the network. Accordingly, these work machines may dynamically exchange and route message packets to perform a variety of work-related functions, such as sharing work machine operations data, position information, updating work machine software, etc.

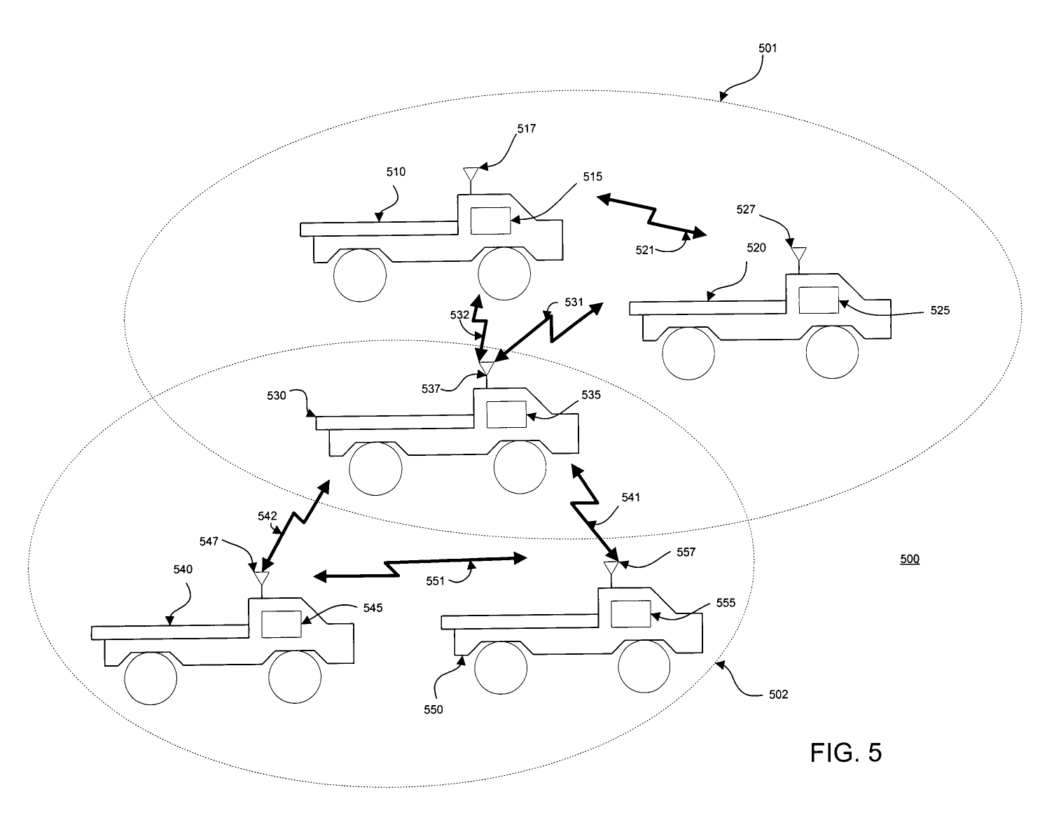

FIG. 5 illustrates an exemplary ad-hoc work machine network environment 500 consistent with embodiments of the present invention. As shown, environment 500 includes a plurality of work machines 510, 520, 530, 540, and 550. Each work machine includes a gateway 515, 525, 535, 545, and 555, respectively. These gateways may be configured, and operate, similar to gateway 120 described above in connection with FIG. 1. Further, work machines 510-550 may also include one or more antennae 517, 527, 537, 547, and 557, respectively, which interface with gateways 515-555 to provide one or more respective off-board data links consistent with embodiments of the present invention. For example, work machine 510 may communicate with work machines 520 and 530 over wireless data links 521 and 532, respectively. Work machine 520 may communicate with work machines 510 and 530 over wireless data links 521 and 531, respectively. Work machine 530 may communicate with work machines 510 and 530 over wireless data links 532 and 531, respectively. Also, work machine 530 may communicate with work machines 540 and 550 over wireless data links 542 and 541, respectively. In addition to communicating with work machine 530 over wireless data links 542 and 541, work machines 540 and 550 may communicate between each other via wireless data link 551.

In accordance with embodiments of the present invention, one or more work machines 510-550 travel during their operations. As the machines travel, they may establish one or more sub-ad-hoc networks with other work machines based on their location and communication capabilities. Collectively, these sub-networks may form an ad-hoc network that allows work machines to communicate packets through intermediate nodes. For example, environment 500 may be an ad-hoc network that includes two sub-ad-hoc networks 501 and 502 that are temporarily established based on the locations of work machines 510-550. Network 501 includes work machines 510-530 and network 502 includes work machines 530-550.

In one embodiment of the invention, each gateway 515-555 may include a network table that includes routing information associated with other work machines when an ad-hoc network is established. The network table may updated periodically based on information associated with changes in the ad hoc network topology. For example, as work machine 510 moves into a location that is within communication range of work machine 520, gateway 515 may collect information from gateway 525 to form a the network table. The network table formed by gateway 515 may include information associated with work machine 520, such as the machine's ID information and any adjacent nodes (e.g., work machines) that are within the communication range of work machine 520. Therefore, work machine 510 now may collect information that allows gateway 515 to perform various intelligent routing and communication operations consistent with embodiments of the present invention.

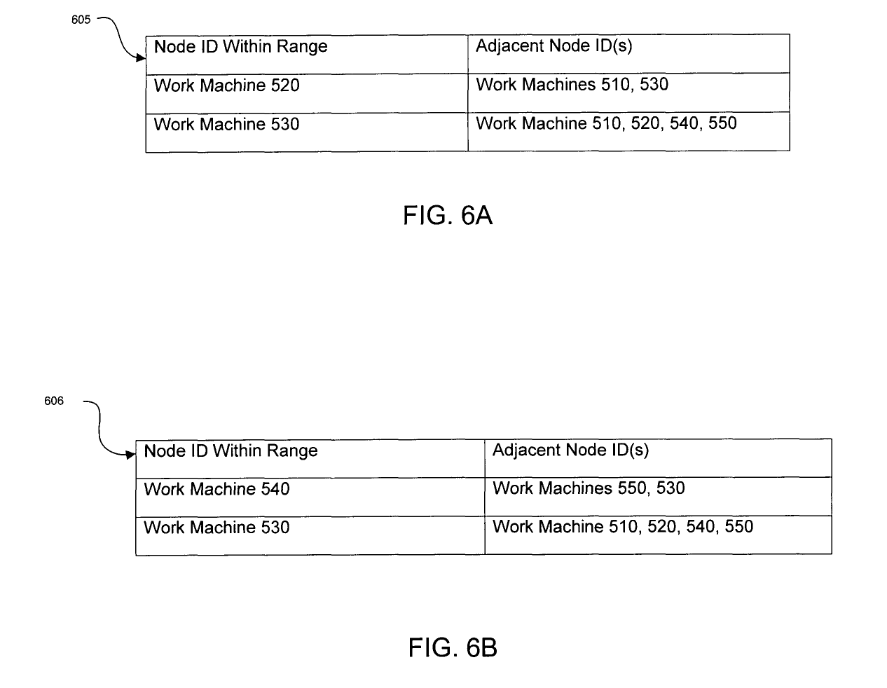

FIGS. 6A and 6B show exemplary network tables that may be discovered (i.e., generated) by gateways 515 and 555, respectively. FIG. 6A shows a network table 605 discovered and/or modified by gateway 515 when either work machine 510 moves within communication range of work machines 520 and/or 530 or vice versa. As shown, network table 605 includes identifier information associated with work machines 520 and 530 and the work machines (e.g., adjacent nodes) that are within communication range of these respective machines. For example, table 605 shows that work machine 530 is in communication range of work machines 510, 520, 540, and 550. Because work machines 510-530 are within communication range of each other, ad-hoc work machine network 501 is established.

FIG. 6B shows a network table 606 discovered and/or modified by gateway 555 when work machine 550 moves within communication range of work machine 540 and/or 530 or vice versa. As shown, table 606 includes identifier information for each machine 540 and 530, as well as corresponding adjacent node information for each machine. For example, table 606 shows that work machine 540 is in communication range of work machines 550 and 530.

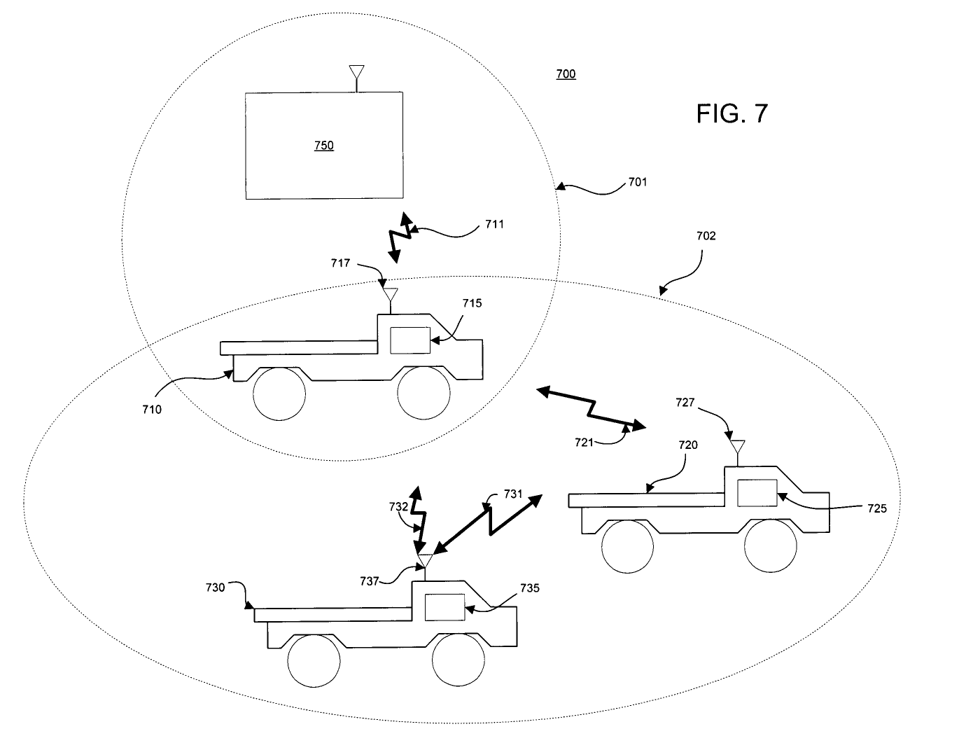

Although methods and systems consistent with embodiments of the present invention allow work machines to maintain current location information for any work machines within its communication range, the gateway embedded work machines may also establish an ad-hoc network with a fixed node, such as a central site office. FIG. 7 illustrates an exemplary work machine environment 700 including an ad-hoc network containing a fixed node. As shown, environment 700 may include, for example, two ad-hoc networks 701 and 702. Network 701 includes work machine 710 and a fixed node 750, such as a central site office located in a particular work environment (e.g., mining site, construction site, service station site, etc.). Network 702 includes work machines 710, 720, and 730. As with machines 510-550 described above in connection with FIG. 5, work machines 710-730 each include gateways 715, 725, and 735, respectively. These gateways may each be configured, or operate, similar to gateway 120 described above in connection with FIG. 1.

Further, work machines 710-730 each include an antenna 717, 727, and 737, respectively, for sending and receiving packets of information from remote nodes (e.g., other work machines, fixed node 750, etc.). Antennae 717-737 may interface with gateways 715-735, respectively, to provide respective off-board data links consistent with embodiments of the present invention. For example, work machine 710 may communicate with work machines 720 and 730 over wireless data links 721 and 732, respectively. Also, work machine 710 may communicate with fixed node 750 over wireless data link 711. Work machine 720 may communicate with work machines 710 and 730 over wireless data links 721 and 731, respectively. Work machine 730 may communicate with work machines 710 and 730 over wireless data links 732 and 731, respectively.

Network 702 may be established based on the movement of work machines 710-730. That is, machines 710-730 are in communication range of one another, thus forming network 702. Network 701 may be established when work machine 710 moves into communication range of fixed node 750.

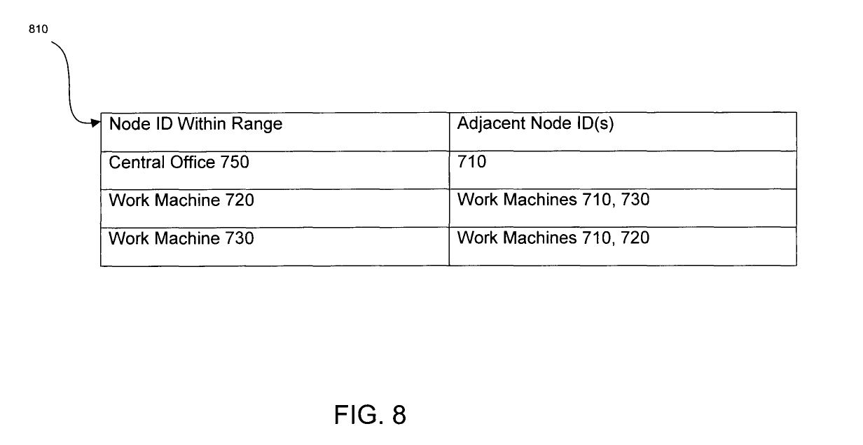

Gateways 715-735 may each discover and/or modify their respective network tables with identification information associated with other nodes (e.g., work machines, fixed nodes, etc.). FIG. 8 shows an exemplary network table 810 discovered and/or modified by gateway 715 in accordance with certain embodiments of the present invention. As shown, table 810 includes identifier information associated with all nodes work machine 710 is able to communicate with and the nodes' corresponding adjacent nodes. For example, table 810 shows that work machine 710 is in communication with a central site office (i.e., fixed node 750). The only adjacent node to central office 750 is work machine 710 itself. Also, table 810 shows that work machine 710 is in communication with work machine 720, which is in communication with work machines 710 and 730 (i.e., adjacent nodes for work machine 720).

Accordingly, a work machine operating in environment 700 may dynamically enter or leave an ad-hoc network based on the machine's current position. Moreover, because work machine 710 may communicate with central office 750, the machine may operate as a temporary access point between work machines 720, 730 and fixed node 750.

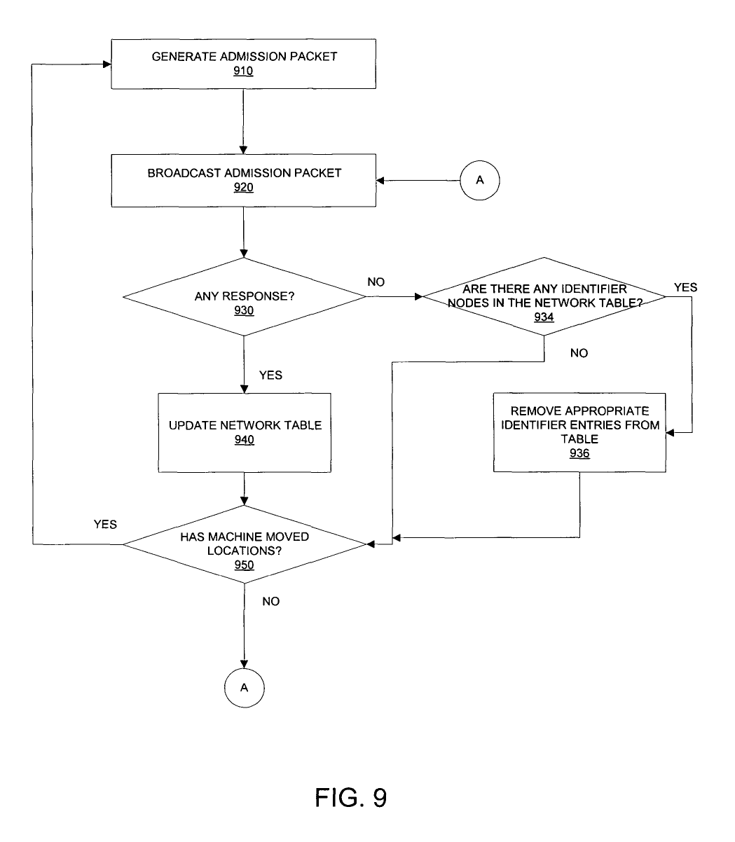

As explained, methods and systems consistent with embodiments of the present invention enable work machines to establish temporary ad-hoc networks while traveling within or between work environments. The manner by which these machines maintain and operate such networks may be associated with the upkeep of their respective network table(s). FIG. 9 shows a flowchart or an exemplary ad-hoc admission process that may be performed by a gateway embedded in a mobile work machine consistent with certain embodiments of the present invention. For exemplary purposes, FIG. 9 will be described with reference to FIG. 5 and work machine 510. It should be noted that any gateway in work machines 510-550 may perform the admission process.

As work machine 510 travels, gateway 515 may be configured to execute a communications application that generates a network admission packet message (Step 910) periodically or at other points in time. This packet may include a request for information from any nodes in the broadcast communications range of antenna 517. Further, the admission packet may include identifier information associated with work machine 510 and any information collected from the machine's network table (e.g., node identifier and adjacent node identifier information). Once generated, work machine 510 may broadcast the admission packet using any data links available to machine 510 in its current location (Step 920). For example, work machine 510 may broadcast the admission packet over a radio data link that may include data links 532 and 521.

Following the transmission of the admission packet, the communications application executed by gateway 515 may monitor any incoming response message packets (Step 930). If there is no response within a certain period of time (Step 930, NO), the communications application may determine whether there are any entries in work machine 510's network table (Step 934). If not (step 934, NO), the communications application may determine whether work machine 510 has moved locations (Step 950). In one embodiment, gateway 515 may retrieve and store GPS location information from a satellite GPS data link. The communications application may check the current GPS location information with the stored value to determine whether work machine 510 has moved beyond a certain distance. If machine 510 has moved beyond that distance (Step 950, YES), the network admission process may continue at Step 910. On the other hand, if machine 510 has not moved beyond the predetermined distance (Step 950, NO), gateway 515 may re-broadcast its admission packet (Step 920).

On the other hand, if the communications application determines that there are entries in the network table (Step 934, YES), gateway 515 may remove any appropriate node identifier entries from the table to reflect that work machine 515 is no longer in communication with any such nodes (e.g., work machines, fixed nodes, etc.) and thus, not part of any ad-hoc work machine network (Step 936). The network admissions process may then continue to Step 950, as explained above.

Referring back to Step 930, if gateway 515 has received a response to its admission packet request (Step 930, YES), gateway 515 may update its network table based on the information received from a responding node (Step 940). This process may include extracting node identifier and adjacent node identifier information from the response and adding this information to work machine 510's network table (e.g., table 605 in FIG. 6A). In one embodiment of the present invention, each of gateways 515-555 may be configured to execute a communications application that responds to a received admission packet by generating a response packet including identifier and adjacent node identifier information it maintains in its network table.

Following, or concurrently with, updating the network table, gateway 515 may determine whether work machine 510 has moved locations (Step 950), and if so, generates another admission packet (Step 910). If machine 510 has not moved locations (Step 950, NO), gateway 515 may re-broadcast its admission packet (Step 920). In another embodiment, instead of determining that work machine 510 has moved locations, gateway 515 may periodically generate admission packets regardless of the machine's location.

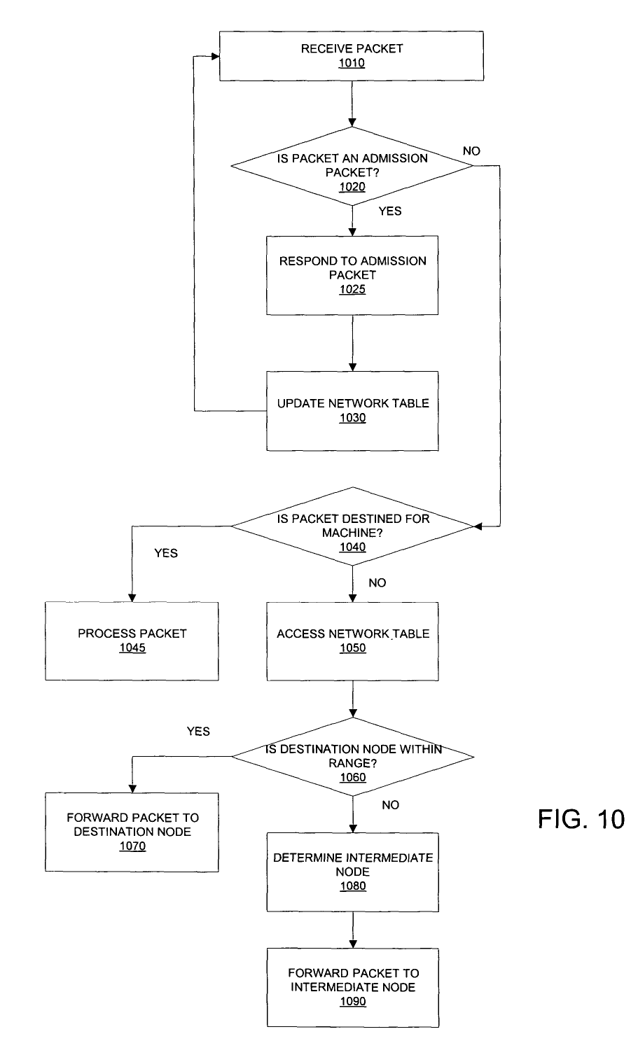

In addition to performing processes that request entry into an ad-hoc work machine network, each work machine's gateway may perform communications process that services received message packet from other nodes. FIG. 10 shows a flowchart of an exemplary ad-hoc communications process that may be performed by a work machine's gateway consistent with embodiments of the present invention. For exemplary purposes, the communications process will be described with reference to FIG. 5 and work machine 530. It should be noted that any gateway in work machines 510-550 may perform the ad-hoc communications process.

During operations, gateway 535 may execute a communications application that detects when a message packet is received from another node (Step 1010). This application may be the same or different from the communications application that performs the network admissions process described above with reference to FIGS. 5 and 9. In one embodiment, gateway 535 may determine whether the received packet is an admission packet (Step 1020). If so (Step 1020, YES), gateway 515 may respond to the admission packet (Step 1025) by accessing work machine 530's network table to collect node identifier and adjacent node identifier information and generating a response packet. Gateway 535 may then transmit the response packet to the node that sent the admission packet detected in Step 1020. Gateway 535 may also use the identifier information included in the admission packet to update work machine 530's network table (Step 1030). Once updated, gateway 535 may return to monitor and/or wait for another packet to be received by antenna 537 (Step 1010).

Returning to Step 1020, if the received packet is not an admission packet (Step 1020, NO), gateway 535 may determine whether the received packet was destined for machine 530 (Step 1040). In one embodiment, gateway 535 may analyze a destination node ID included in the received packet to determine the node that is to process the packet. If the node is to process the packet (Step 1040, YES), gateway 535 processes the packet and its information in a manner consistent with embodiments of the present invention (e.g., translate and send a message to an on-board module, execute another application on gateway 535, etc.) (Step 1045). On the other hand, if the packet is not destined for work machine 530 (Step 1040, NO), gateway 535 may access its network table to determine whether the destination node identified in the received packet is included in the node identifier or adjacent node identifier column of the table (Step 1050). Gateway 535 may search the network table to determine whether the destination node is directly accessible by work machine 530 (i.e., node within range) (Step 1060). If the destination node is within communication range of work machine 530 (Step 1060, YES), gateway 535 may forward the received packet to the proper destination node for subsequent processing (Step 1070).

On the other hand, if the destination node is out of communication range of work machine 530 (Step 1060, NO), gateway 535 may determine which work machine that is in communication range of machine 530 may communicate with the destination node (Step 1080). Gateway 535 then forwards the packet to the determined intermediate node for subsequent packet routing (Step 1090).

To explain the communication process described in connection with FIG. 10, consider the following example. Suppose work machine 550 generates a message packet destined for work machine 510. Machine 550 may send the packet to work machine 530 because work machine 510 is out of communication range of machine 550 and work machine 530 is within communication range of machine 550. In this example, gateway 555 may determine that machine 530 is the appropriate intermediate node to send the packet based on its network table identifying work machine 530 as being in communication range of machine 510 (see table 606, FIG. 6B). When the packet is received at work machine 530, gateway 535 may determine that the packet is destined for work machine 510, which is in communication range of machine 530. Accordingly, gateway 535 may forward the packet to work machine 510 for subsequent processing.

In one embodiment of the invention, if gateway 555 determines that there are two or more work machines that may act as an intermediate node, gateway 555 may execute an arbitration process to determine the node that is best suited for receiving the packet. For example, gateway 555 may determine the best suited intermediate node based on data link availability, quality of service, bandwidth, amount of data to be transmitted, priority of message, positions of the candidate intermediate nodes, velocity and direction of work machine 530 or any of the candidate intermediate nodes, such as work machine 540, and any other type of characteristic that may allow gateway 555 to determine which intermediate node is best suited to pass the packet to the destination node.

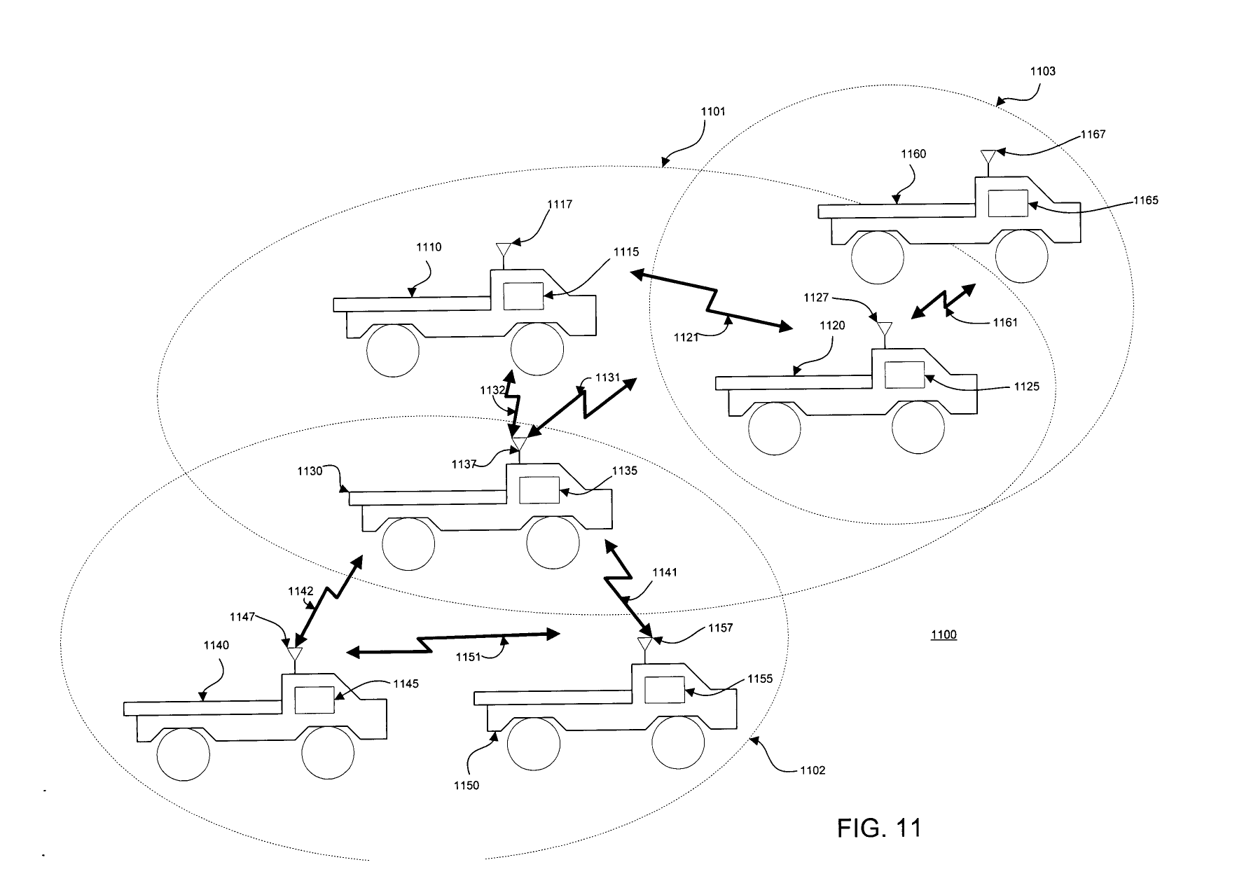

Ad-hoc network environment 500 described in connection with FIG. 5 may be considered a single level network environment where each work machine's network table will include an identifier of at least every node in ad-hoc network 500. For example, work machine 550's network table will at least include adjacent node identifiers for work machines 510 and 520 via work machine 530's identifier in the table. Methods and systems consistent with embodiments of the present invention may be configured to handle multiple level ad-hoc networks where a work machine may locate a destination node through more than two sub-ad-hoc networks. FIG. 11 shows a block diagram of an exemplary multiple layer ad-hoc network environment 1100 consistent with embodiments of the present invention.

Environment 1100 includes work machines 1110-1160. Each machine includes an antenna 1117-1167 and a gateway 1115-1165, respectively. Gateways 1115-1165 may be configured, and operate, similar to gateways 515-555 described above in connection with FIG. 5. Environment 1100 also includes three sub-networks 1101, 1102, and 1103 that make up the ad-hoc network environment 1100. Sub-networks 1101 and 1102 are established based on the positions of work machines 1110-1150, in a manner similar to that described above in connection with sub-networks 501 and 502 of FIG. 5. Sub-network 1103 may be established when either work machines 1160 or 1120 move into communication range of each other such that message packets may be exchanged over wireless data link 1161.

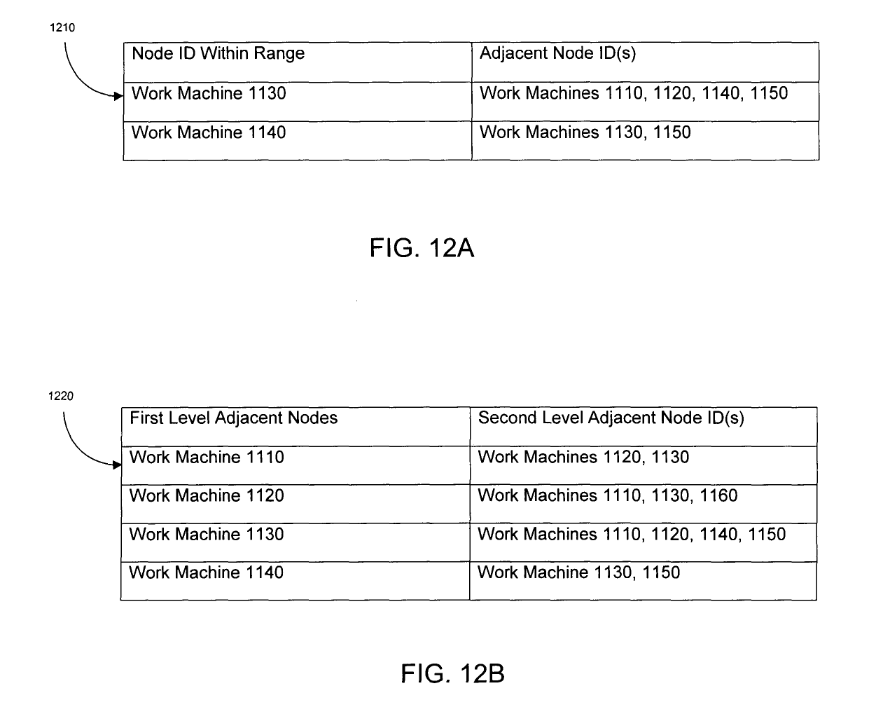

To handle communications within multi-level ad-hoc network environment 1100, gateways 1115-1165 may be configured to generate and maintain multiple levels of network tables that include identifiers associated with all nodes included in network environment 1100. FIGS. 12A and 12B shows exemplary network tables for work machine 1150 in accordance with one embodiment of the invention.

FIG. 12A shows an exemplary first level network table 1210 for work machine 1150. Table 1210 may be configured and populated in a manner consistent with the network tables described in connection with FIGS. 6A and 6B for work machines 510-550 in FIG. 5. That is, table 1210 includes node identifiers for work machines within machine 1150's communication range (e.g., work machines 1130 and 1140) and identifiers for work machines within the communication range of those previously identified machines (e.g. work machines 1110-1150). As can be seen, however, work machine 1160 is not included in first level network table 1210 because the machine is not in communication range of any of the adjacent nodes identified in table 1210. Accordingly, methods and systems consistent with certain embodiments of the present invention may allow gateways 1115-1165 to include a second network table 1220 shown in FIG. 12B. Table 1220 lists the work machines that are included as adjacent nodes in the first level network table 1210. Further, table 1220 lists the nodes that are in communication range of each of the first level adjacent nodes (i.e., second level adjacent nodes). As can be seen, work machine is listed in the second level adjacent node for work machine 1120. Therefore, using the second level network table 1220, work machine 1150 may identify the proper intermediate node to direct a packet message destined for work machine 1160.

Second level network table may be updated by gateway 1155 when a remote work machine responds to an admission packet. In this instance, the remote work machine may provide node identifier information for first and second level nodes in a manner consistent with the admission packet process described above in connection with FIGS. 9 and 10. Thus, all work machines within ad-hoc network environment 1100 will include identifier information for all other nodes in the network, either in a first level or second level network table format.

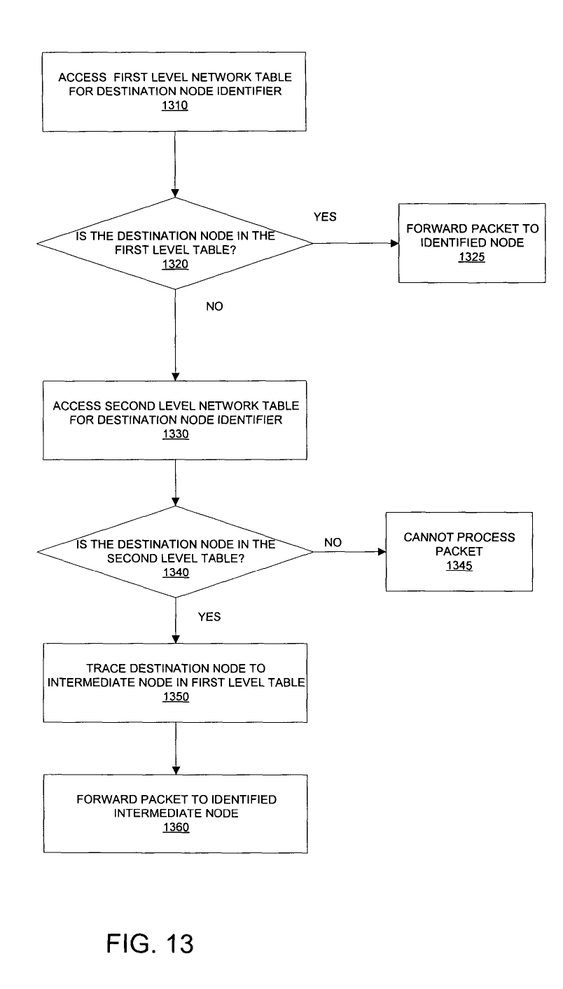

To better describe the use of multi-layer network tables, FIG. 13 shows a flowchart of an exemplary multi-layer communications process that may be performed by any of gateways 1115-1165 consistent with embodiments of the present invention. For exemplary purposes, FIG. 13 will be described with reference to FIG. 11 and work machine 1150 forwarding a packet to work machine 1160 as the destination node; however, the following description may apply to any of work machines 1110-1160 and gateways 1115-1165 sending packets to any destination node within network environment 1100.

Initially, whether work machine 1150 receives or generates a message packet, gateway 1155 may access its first level network table (e.g., table 1210) to determine whether the destination node ID (e.g., work machine 1160) is located therein (Step 1310). If the destination node is listed in first level table 1220 (Step 1320, YES), gateway 1155 may forward the packet to the appropriate work machine in a manner consistent with the process described in connection with FIG. 10. On the other hand, if the destination node is not listed in first level network table 1220 (Step 1320, NO), gateway 1155 may access the second level network table 1220 (Step 1330). Gateway 1155 may determine whether the destination node is listed in table 1220, and if not (Step 1340, NO), gateway 1155 may determine that the packet cannot be transmitted because the destination node is not included in ad-hoc network 1100 (Step 1345). In this case, gateway 1155 may provide a failure message to the source of the packet to be sent to the destination node, which may be another work machine or an application process executing within gateway 1155 that generated the packet.

However, if the destination node is listed in the second level table 1220 (Step 1340, YES), gateway 1155 may trace the destination node to the appropriate intermediate first level adjacent node (Step 1350). For example, referring to FIG. 12B, gateway 1155 may locate work machine identifier 1160 in the second level adjacent node column of table 1220. Accordingly, gateway 1155 may trace work machine 1160 to work machine 1120 listed in the first level adjacent node column of table 1220. From here, gateway 1155 may access the first level network table 1210 to identify the intermediate node that corresponds to the first level adjacent node 1120, which in this case is work machine 1130. Once this node is identified, gateway 1155 may forward the packet to the identified intermediate node for further routing (e.g., work machine 1130) (Step 1360).

Therefore, using the first and/or second level network tables, work machines 1110-1160 may identify the appropriate intermediate work machines that are in communication with either other intermediate work machines or the destination node, to properly and efficiently forward message packets to the destination node. In the above example, the routing path would start at work machine 1150 and follow the path including work machines 1130, 1120, and 1160.

Remote Operation of Work Machines

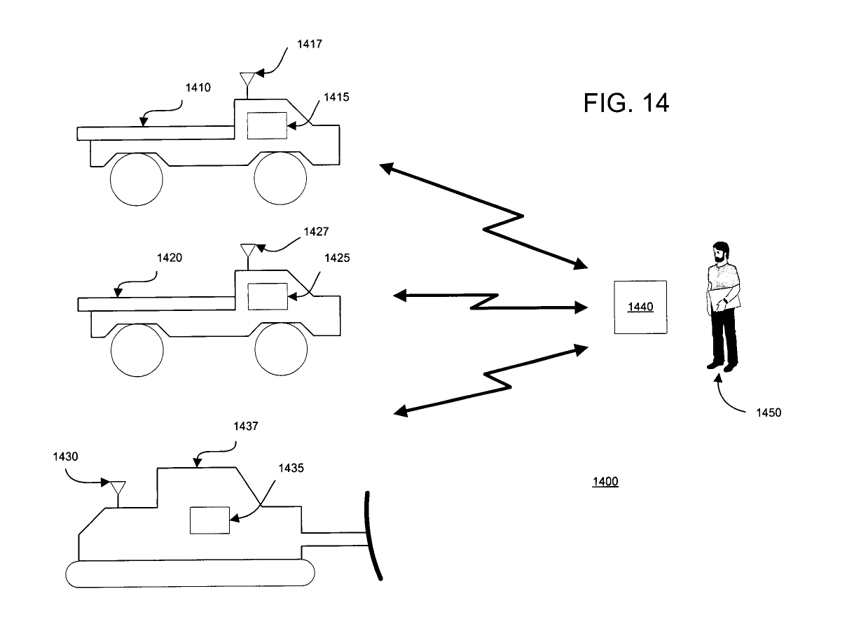

In addition to dynamically forming ad-hoc networks to intelligently route message packets between work machines moving within and/or between work environments, methods and systems consistent with embodiments of the present invention also allow for remote operation of work machines using the gateways embedded in these machines. FIG. 14 shows an exemplary remote operation work machine environment 1400 consistent with embodiments of the present invention.

Environment 1400 may include, for example, one or more work machines 1410, 1420, and 1430 of similar or different types. For instance, work machine 1410 may be a work machine of a first type (e.g., dump truck), work machine 1420 may be a work machine of a second type that may be the same or different than the first type, and work machine 1430 may be a work machine of a third type that is different from the first and/or second type (e.g., bulldozer). Each of work machines may include one or more antennae 1417, 1427, and 1437, respectively, that allow for wireless communications between work machines 1110-1130 and other off-board systems. Further, work machines 1410-1430 may also include a gateway 1415-1435, respectively, that are each configured, and operate, similar to gateways 515-555 or 1115-1165.

Environment 1400 may also include an off-board system 1440 that may be a computer system connected to an antenna (not shown) capable of sending and receiving message packets to and from work machines 1410-1430. System 1440 may be a computer system operated by a user 1450 that provides one or more commands that are destined for one or more of work machines 1410-1430. Computer system 1440 may be a portable computer system, such as a lap top, personal digital assistant, web-enabled cell-phone, etc. that includes, or is connected to, components that facilitate the wireless communications described above. Alternatively, system 1440 may be a desktop computer system that is located in a work environment site office positioned within one of the work environments that work machines 1410-1430 may travel within or between. Also, system 1440 may be a computer system located in a central office site positioned remote from any of the work environments work machines 1410-1430 may operate within, such as an office located many miles away. In this situation, computer system 1440 may use Ethernet data links to communicate with work machines 1410-1430 via a wireless transmission access point located in one of the work environments the machines operate within. In one embodiment, system 1440 may be mounted on one of the work machines in the ad hoc work machine network.

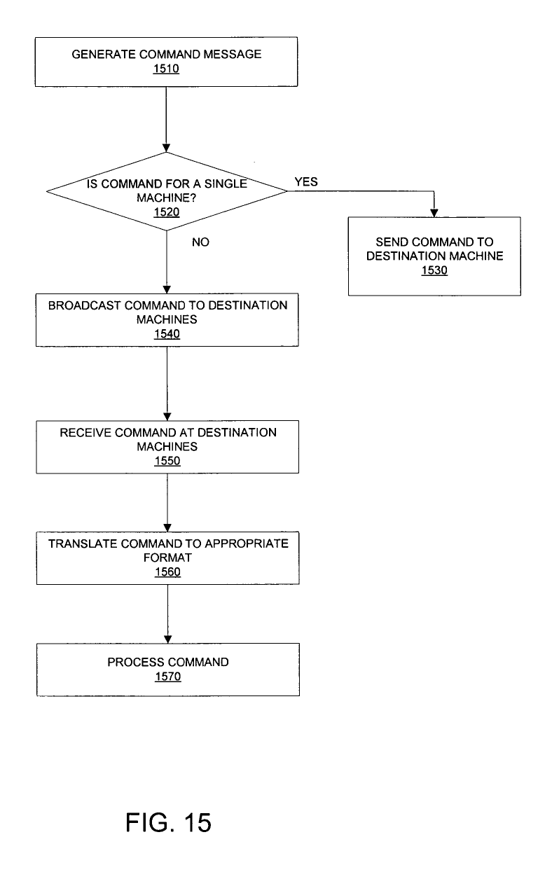

FIG. 15 shows a flowchart of an exemplary remote operation process consistent with embodiments of the present invention. When a user, or a software program executing on system 1440, desires to perform some operation on one or more work machines 1410-1430 from a remote location, a command message is generated that includes one or more commands associated with an operational characteristic of the machines (Step 1510). For example, user 1450 may be a service technician who wishes to perform a service check on one or more of work machines 1410-1430. Accordingly, user 1450 may generate a command to configure work machines 1410-1430 in a specified diagnostic mode resulting in one or more on-board modules within each of the machines to adjust a controlled machine component.

Computer system 1440 may be configured to determine whether the command is targeted for a single work machine (Step 1520). If so (Step 1520, YES), system 1440 may add the command in a command packet and send the packet to the appropriate work machine (Step 1530) using the wireless data link communicating with that machine. For example, work machine 1410 may receive the command message from system 1440 over a radio data link and translate the received message in accordance with the translating features associated with certain embodiments of the present invention. Once translated, gateway 1415 may provide the command to the appropriate on-board module connected to an on-board data link (e.g., data links 128, 129). The destination on-board module may perform an operation in accordance with the command and perhaps provide feedback information to gateway 1415 for delivery to system 1440.

Referring back to Step 1520, if computer system 1520 determines that the command is directed to more than one work machine (Step 1520, NO), system 1440 may include the command in a command packet and broadcasts the packet to the appropriate work machines, which may be all machines 1410-1430 or any combination thereof (Step 1540). The command message is received at the work machines (Step 1550) where the machine's gateways (i.e., gateways 1415-1435) may translate the command packet to the appropriate format for transfer to a target on-board module or process (Step 1560). Once each work machine translates (if required) the command message, the machine may perform its respective operation based on the instructions included in the command (Step 1570).

Accordingly, a user may control one or more work machines using a single command or multiple commands transmitted from a single location (e.g., computer system 1440). Because the gateways embedded within each machine 1410-1430 are configured in a manner consistent with embodiments of the present invention, the command may be sent in a format that is different from that compatible with on-board modules operating within each work machine. The embedded gateways may translate the command message to ensure the instructions included within the command message are in the proper format for subsequent processing.

Industrial Applicability

Methods and systems consistent with embodiments of the present invention allow work machines to dynamically establish one or more ad-hoc work machine networks as the machines travel within or between work environments. Such systems and methods facilitate the transmission and routing of message packets between moving work machines without the need for any fixed access point facilities. In some embodiments, a moving working machine may act as a temporary access point that delivers message packets to a fixed node within a particular network.

The embodiments of the present invention may be applied to various applications to allow work machines to share information without the constraint of fixed network boundaries. For example, work machines in a mining work environment may receive and share status information regarding the overall performance of the environment, the performance of individual machines within the environment. Also, a central site office may issue a software update message to update the software of an on-board module of particular types of work machines operating within a work environment. In such an example, the central office may send the update information in a packet that is received by one or more work machines that are in communication range of the office. The work machines may process the information (i.e., update its software if the machine matches the type of machine identified in the message) and forward the packet to other work machines that are included in an ad-hoc network containing the machine that initially received the update message. Other types of messages, data, and information may be relayed between work machines as well.

In another embodiment, the remote operation process may be performed in conjunction with the ad-hoc communications processes described above. That is, any work machine in ad-hoc network environment 500 or 1100 may receive an off-board command message from computer system 1440, and forward the command to the appropriate machine using the intelligent ad-hoc routing processes described in connection with FIGS. 5-13.

Further, in another embodiment, during the remote operation process described in connection with FIG. 15, any of gateways 1410-1430 that receive a command message may perform the firewall application process previously described, to ensure only authorized sources are attempting to control the operations of the work machines. This may include checking a PID included in the command message to determine whether the requested remote operation is a valid and authorized command.

Also, in other embodiment, gateways 515-555 or 1115-1165 may also perform the firewall application processes described above to ensure any message packets that are received from a source node (e.g., a work machine or fixed node) are authorized to communicate and/or send packets in any of the established ad-hoc networks. This may be applicable in situations where a work environment includes multiple types of work machines operating within communication range of each other and the machines are transmitting wireless messages within the environment. In some instances, only a portion of the machines operating in the environment may be associated with each other (e.g., built by the same manufacturer, are a similar or same type of work machine, have the same authorization levels, etc.). Accordingly, by exploiting the firewall application processes executed by the gateways in a manner consistent with embodiments of the present invention, a work environment may enable limited numbers of work machines to establish ad-hoc networks while preventing third party machines from intercepting and/or inadvertently processing message packets transmitted between the ad-hoc work machines.

In yet another embodiment, a user may remotely control a work machine to perform one type of operation, while simultaneously monitoring or instructing another machine (of the same or different type) to perform a different operation. In this embodiment, the user (or computer system 1440) may batch commands with associated destination node identifiers in a single command message. Computer system 1440 may broadcast the message to multiple work machines that determine from the corresponding destination identifiers whether a certain command included in the batch commands is destined for a specific machine. Further, in an ad-hoc network environment, a intermediate work machine may extract a command from a batch command message destined for that machine, while forwarding the command message to other work machines within communication range of its antenna.

In another embodiment, each work machine included in an ad-hoc network environment may include communications applications executed by a gateway that dynamically determine a type of data link to use for forwarding or sending a message packet. For example, each work machine may include multiple wireless antennae that communicates with off-board systems using different types of data links (e.g., IEEE 802.11 standard data link, wireless cellular network, etc.) During operations, the work machine may select which data link to use for transmitting a message packet based on one or more characteristics. These characteristics may be associated with the availability of the data links, the cost of communicating over one data link compared to another, the quality of service associated with the data links, the priority of the message packet (e.g., an alarm message versus a status request), transmission time associated with the data links, and any other type of characteristic associated with the data links and/or the type of message packet being sent by the work machine. Accordingly, a gateway operating within each work machine may dynamically format a message packet being sent to a destination node based on the above described conditions and the type of data link selected.

Further, each node (e.g., work machine) may pass positional information to neighboring nodes in an ad-hoc work machine network. Using the positional information, each work machine's gateway may determine or assist in determining one or more routing paths to follow in the network based on ranges between machines.

The ad hoc protocol described herein may be considered proactive (i.e. each work machine maintains respective network tables). In another embodiment, methods and systems consistent with the present invention may implement reactive protocols (e.g., DSR, AODV, etc. ) that allow each node to discover routes within the work machine network as the are needed. For example, instead of passing admission packets between each other, work machines 1110-11160 in FIG. 11 may determine a routing path when a message packet is received. Therefore, consider the example where work machine 1130 receives a packet from machine 1150 that is destined for machine 1160. Once the packet is received, gateway 1135 may be configured to request information from neighboring work machines (e.g., machines 1110, 1120, 1140) to identify any machine that are connected to the destination machine (e.g., machine 1160). In this example, work machine 1120 may return information to machine 1130 identifying it as an adjacent node to destination machine 1160. Therefore, work machine 1130 may determine the routing path to include work machine 1120 and forwards the message packet to that machine for subsequent forwarding to destination machine 1160.

The above exemplary reactive protocol may also be applied in multiple level ad-hoc networks where a destination machine is many nodes removed from a source work machine. In such a case, adjacent nodes receiving an information request from a source node may pass the request to adjacent nodes to help identify a node that is adjacent to the destination work machine. Once one or more such nodes are identified, this information may be passed back to the source machine for determining the appropriate routing path for sending the message packet.

The embodiments, features, aspects and principles of the present invention may be implemented in various environments and are not limited to work site environments. For example, a work machine with an embedded gateway may perform the functions described herein in other environments, such as mobile environments between job sites, geographical locations and settings. Further, the processes disclosed herein are not inherently related to any particular system, and may be implemented by a suitable combination of electrical-based components. For example, the wireless communications between work machines may be accomplished by other technologies different from radio transmission and reception using antennae, such as by transmissions and receiving devices for communication by light pulses. Other embodiments of the invention will be apparent to those skilled in the art from consideration of the specification and practice of the invention disclosed herein. It is intended that the specification and examples be considered as exemplary only, with a true scope of the invention being indicated by the following claims.

1. A method for dynamically establishing an ad-hoc network including a plurality of work machines, one or more of which may move within a work environment and each of which includes a gateway, the method performed by a respective gateway included within a respective one of the work machines comprising:
determining a first set of work machines that are within direct communication range of the respective work machine based on the work machine's current location within the work environment;
determining a second set of work machines that are in direct communication range of one or more of the work machines in the first set;
forwarding a packet received from a first work machine included in the first set to a second work machine included in the first set based on a determination that the second work machine is either directly or indirectly within communication range of a third work machine included the second set; and
updating the work machines included in at least one of the first and second set of work machines based on at least one of (i) the respective work machine changing locations within the work environment and (ii) any of the work machines included in the first or second sets changing locations within the work environment.

2. The method of claim 1, wherein the packet is destined to a destination work machine not included in the first or second set of work machine, and forwarding the packet includes:
forwarding the packet to the second work machine based on a determination that the third work machine is in direct communication range of the destination work machine.

3. The method of claim 1, wherein the packet is destined to a destination work machine not included in the first or second set of work machine, and forwarding the packet includes:
forwarding the packet to the second work machine based on a determination that the third work machine can indirectly communicate with the destination work machine.

4. The method of claim 1, wherein determining the first set of work machines includes:
broadcasting an admission packet;
receiving a response from at least one of the first and second work machines; and
adding at least one of the first and second remote work machines to the first set of work machines based on the received response.

5. The method of claim 4, wherein determining a second set of work machines includes:
collecting, from the response, an identifier associated with the third work machine; and
adding the third work machine to the second set of work machines, wherein the identifier reflects that at least one of the first and second work machines are either directly or indirectly in communication with the third work machine.

6. The method of claim 1, wherein updating the work machines included in the at least one of the first and second set of work machines further includes:
determining that the respective work machine has moved to a first location; and
repeating the determining of the first set of work machines when the first location is beyond a certain distance from the current location.

7. The method of claim 1, wherein updating the work machines included in the at least one of the first and second set of work machines further includes:
periodically repeating the step of determining the first set of work machines.

8. The method of claim 1, wherein updating the work machines included in the at least one of the first and second set of work machines further includes:
removing from the first set any work machines that are not in direct communication with the respective work machine.

9. The method of claim 8, wherein updating the work machines included in the at least one of the first and second set of work machines further includes:
removing from the second set any work machines that are not in direct communications with any work machines included in the first set.

10. The method of claim 1, wherein the respective work machine is connected to at least two data links capable of transmitting the packet from the respective work machine and forwarding the packet further includes:
selecting one of the at least two data links to forward the packet to the first work machine based on at least one of an availability status of each of the data links, the cost of communicating over each data link, a quality of service associated with each data link, a priority of the packet, and a transmission time associated with each data link.

11. The method of claim 1, wherein the packet is destined to a destination work machine and the respective gateway includes a first network table, and forwarding the packet includes:
forwarding the packet to the second work machine based on a determination that the second work machine is associated with the destination work machine in the first network table.

12. The method of claim 1, wherein the packet is destined to a destination work machine and the respective gateway includes a first and second network table, and forwarding the packet includes:
forwarding the packet to the second work machine based on a determination that the destination work machine is associated with the third work machine in the second network table and the third work machine is associated with the second work machine in the first network table.

13. A system for dynamically establishing communications between work machines, one or more of which may move within a work environment, the system comprising:
a first work machine positioned in a first location within the work environment;
a first gateway included in the first work machine that connects an on-board data link with an off-board data link; and
a network table included in the first gateway that identifies work machines that are either directly or indirectly within communication range of the first work machine, wherein the network table identifies a first set of work machines that are within communication range of the first work machine and identifies a second set of work machines that are within communication range of any of the work machines in the first set,
wherein the first gateway is configured to:
update the network table based on at least one of (i) the first work machine changing locations within the work environment and (ii) any of the work machines included in the first or second sets changing locations within the work environment,
receive a packet over the off-board data link from a second work machine included in the first set, wherein the packet identifies a destination work machine,
forward the received packet to a third work machine included in the first set based on a determination that the destination work machine is associated with the third work machine in the network table, and
send information included in the received packet to the on-board data link when the packet identifies the first work machine as the destination work machine.

14. The system of claim 13, wherein the first gateway is configured to update the work machines included in the at least one of the first and second set of work machines identified in the network table based on at least one of (i) the first work machine moving out of communication range of any work machine in the first set, (ii) any one of the work machines included in the first set moving out of communication range of the first work machine, (iii) any one of the work machines in the first set moving out of communication range of any one of the work machines in the second set, and (iv) any of the work machines in the second set moving out of communication range of any one of the work machines in the first set.

15. The system of claim 13, wherein the network table includes a first level table identifying the first and second set of work machines and a second level table identifying a third set of work machines that are within communication range of any of the work machines in the second set, and wherein the first gateway is further configured to:
forward the packet to the third work machine based on a determination that the destination work machine is associated with a fourth work machine included in the third set and the third work machine is associated with the fourth work machine in the second level table.

16. The system of claim 13, wherein the first gateway is further configured to:
broadcast an admission packet;
receive a response from at least one of the second and third work machines; and
add at least one of the second and third remote work machines to the first set of work machines based on the received response.

17. The system of claim 13, wherein the first gateway is further configured to:
periodically broadcast an admission packet to determine whether the first work machine is within communication range of any of the work machines in the work environment.

18. The system of claim 17, wherein the first gateway is further configured to:
remove a work machine from the first set when the first work machine can no longer directly communicate with that work machine.

19. The system of claim 17, wherein the first gateway is further configured to:
remove a work machine from the second set when the work machine can no longer directly or indirectly communicate with the destination work machine.

20. The system of claim 13, wherein the first work machine is connected to at least two data links capable of transmitting the packet from the first work machine and the first gateway is further configured to:
select one of the at least two data links to forward the packet to the third work machine based on at least one of an availability status of each of the data links, the cost of communicating over each data link, a quality of service associated with each data link, a priority of the packet, and a transmission time associated with each data link.

21. The system of claim 13, wherein the first gateway is further configured to:
translate the information included in the received packet to a format compatible with the on-board data link when the packet identifies the first work machine as the destination work machine.

22. The system of claim 13, wherein the third work machine includes a respective gateway that is configured to check a respective network table to identify a fourth work machine that is either directly or indirectly in communication with the destination work machine and forward the packet received from the first work machine to the fourth work machine.

23. The system of claim 13, wherein the first gateway is configured to:
trace the network table to determine the association between the third work machine and the destination work machine.

24. The system of claim 23, wherein the association between the third work machine and destination work machine includes an intermediate work machine that is in direct communication with the third and destination work machines.

25. A gateway included in a first work machine located in a work environment comprising one or more other work machines, each work machine capable of moving within the work environment, the gateway comprising:
a first interface connected to an on-board data link interconnecting one or more on-board modules; and
a second interface connected to one or more off-board data links each capable of being communicatively connected to any of the other machines,
wherein the gateway includes:
means for sending an admission packet over one of the off-board data links, the admission packet including a first identifier associated with the first work machine,
means for determining whether a response to the admission packet is received,
means for updating a network table based on the determination, wherein the network table includes a second identifier associated with a second work machine that is in communication range of the first work machine and a third identifier associated with a third work machine that is in communication range of the second work machine, and
means for forwarding a packet received from the second work machine to the third work machine based on a determination that the third network work machine is identified in the network table.

26. A computer-readable medium including instructions for performing, when executed by a processor, a method for dynamically establishing an ad-hoc network including a plurality of work machines, one or more of which move within a work environment and each of which includes a gateway, the method performed by a respective gateway included within a respective one of the work machines comprising:
determining a first set of work machines that are within direct communication range of the respective work machine based on the respective work machine's current location within the work environment;
determining a second set of work machines that are in direct communication range of one or more of the work machines in the first set;
forwarding a packet received from a first work machine included in the first set to a second work machine included in the first set based on a determination that the second work machine is either directly or indirectly within communication range of a third work machine included the second set; and
updating the work machines included in at least one of the first and second set of work machines based on at least one of (i) the respective work machine changing locations within the work environment and (ii) any of the work machines included in the first or second sets changing locations within the work environment.

27. The computer-readable medium of claim 26, wherein the packet is destined to a destination work machine not included in the first or second set of work machine, and forwarding the packet includes:
forwarding the packet to the second work machine based on a determination that the third work machine is in direct communication range of the destination work machine.

28. The computer-readable medium of claim 26, wherein the packet is destined to a destination work machine not included in the first or second set of work machine, and forwarding the packet includes:
forwarding the packet to the second work machine based on a determination that the third work machine can indirectly communicate with the destination work machine.

29. The computer-readable medium of claim 26, wherein determining the first set of work machines includes:
broadcasting an admission packet;
receiving a response from at least one of the first and second work machines; and
adding at least one of the first and second remote work machines to the first set of work machines based on the received response.

30. The computer-readable medium of claim 29, wherein determining a second set of work machines includes:
collecting, from the response, an identifier associated with the third work machine; and
adding the third work machine to the second set of work machines, wherein the identifier reflects that at least one of the first and second work machines are either directly or indirectly in communication with the third work machine.

31. The computer-readable medium of claim 26, wherein updating the work machines included in the at least one of the first and second set of work machines further includes:
determining that the respective work machine has moved to a first location; and
repeating the determining of the first set of work machines when the first location is beyond a certain distance from the respective work machine's current location.

32. The computer-readable medium of claim 26, wherein updating the work machines included in the at least one of the first and second set of work machines further includes:
periodically repeating the step of determining the first set of work machines.

33. The computer-readable medium of claim 26, wherein updating the work machines included in the at least one of the first and second set of work machines further includes:
removing from the first set any work machines that are not in direct communication with the respective work machine.

34. The computer-readable medium of claim 33, wherein updating the work machines included in the at least one of the first and second set of work machines further includes:
removing from the second set any work machines that are not in direct communications with any work machines included in the first set.

35. The computer-readable medium of claim 26, wherein the respective work machine is connected to at least two data links capable of transmitting the packet from the respective work machine and forwarding the packet further includes:
selecting one of the at least two data links to forward the packet to the first work machine based on at least one of an availability status of each of the data links, the cost of communicating over each data link, a quality of service associated with each data link, a priority of the packet, and a transmission time associated with each data link.

36. The computer-readable medium of claim 26, wherein the packet is destined to a destination work machine and the respective gateway includes a first network table, and forwarding the packet includes:
forwarding the packet to the second work machine based on a determination that the second work machine is associated with the destination work machine in the first network table.

37. The computer-readable medium of claim 26, wherein the packet is destined to a destination work machine and the respective gateway includes a first and second network table, and forwarding the packet includes:
forwarding the packet to the second work machine based on a determination that the destination work machine is associated with the third work machine in the second network table and the third work machine is associated with the second work machine in the first network table.

38. A method for dynamically establishing an ad-hoc network including a plurality of work machines, one or more of which may move within a work environment and each of which includes a gateway, the method performed by a respective gateway included within a respective one of the work machines comprising:
determining a first set of work machines that are within direct communication range of the respective work machine based on the work machine's current location within the work environment;
determining a second set of work machines that are in direct communication range of one or more of the work machines in the first set; and
forwarding a packet to a second work machine included in the first set based on a determination that the second work machine is either directly or indirectly within communication range of a third work machine included the second set, wherein the packet is either (i) received from a first work machine included in the first set or (ii) generated within the respective work machine,
wherein determining a first set, determining a second set, and forwarding are performed when the respective work machine is prepared to forward the packet to another work machine.
